(19) United States
(12) Patent Application Publication
(10) Pub. No.: US 2003/0065519 A1
(43) Pub. Date: Apr. 3, 2003

(54) Method and system for generating legal agreements

(76) Inventors: Henry Gibson, Amherst, MA (US); Sandra Barry, Pittsfield, MA (US); Margaret Biernarcki, Pittsfield, MA (US); Karen Hayden, Adams, MA (US); Sue Ramsdell, Pittsfield, MA (US); Carolyn G. Renzi, Pittsfield, MA (US); Charlene E. Reardon, Pittsfield, MA (US); Elizabeth A. Thoresen, Stamford, VT (US); John B. Yates, Glenmont, NY (US)

Correspondence Address: CANTOR COLBURN, LLP, 55 GRIFFIN ROAD SOUTH, BLOOMFIELD, CT, 06002

(21) Appl. No.: 09/682,645

(22) Filed: Oct. 1, 2001

(51) Int. Cl. G06F 17/60

(52) U.S. Cl. 705/1

(57) ABSTRACT

An exemplary embodiment of the invention relates to a computer-based system and method for automating administration functions in a network environment, and more particularly, for creating and processing non-disclosure agreements. The system comprises a server, a database in communication with the server, an agreement processing and tracking application in communication with said server, a workstation, an agreement screen window on the workstation, an input device for inputting information requested by the agreement screen window, and a computer network connecting the server to the workstation. The information inputted into the workstation is transferred to the server and made available to the agreement processing and tracking application and an agreement processed by the application is made available to the workstation.

### BACKGROUND OF INVENTION

This invention relates generally to a computer-based method and system, and, more particularly, this invention relates to a computer based method and system for generating legal non-disclosure agreements.

Non-disclosure agreements, also known as “confidentiality agreements”, are documents typically prepared by, or on behalf of, a commercial entity. Businesses that seek to negotiate or conduct business with other commercial entities often share sensitive and proprietary information that they would otherwise need to protect from disclosure. Types of confidential information include, but are not limited to, trade secrets, financial data, marketing techniques and materials, business plans and strategies, business operations and systems, pricing policies, information concerning employees, customers, and/or vendors, inventions, research and development, and manufacturing processes. In order to protect this information, businesses commonly execute non-disclosure agreements that define the duties and obligations of the information-receiving party (or “recipient”) regarding restrictions on the handling and use of the information disclosed. These agreements bind the recipient to confidentiality for the duration of time stated in the agreement as set by the parties.

Non-disclosure agreements can be unilateral (binding only one party), whereby one party (the “discloser”) is unilaterally disclosing confidential information to another party; or bilateral (binding both parties), where both parties are disclosing confidential information to each other. For many businesses drafting, reviewing, and executing these agreements are tedious and time-consuming tasks.

Utilizing existing methods, a typical non-disclosure agreement can take days or even weeks to complete. Usually there are multiple parties or departments involved in the drafting process, resulting in the drafts being transferred from person to person for review, revision, and approval. In a typical organization, the process of generating a non-disclosure agreement begins with a request from a person who is directed by an administrator to fill out a request form or data input sheet. This request form typically contains information that is necessary to prepare an agreement draft, e.g., the other party's names, business address, the purpose of the request, the type of information or samples to be exchanged, and the basic terms of the agreement. The administrator or manager manually reviews the request form, checking for missing information. If the request form is incomplete, the administrator would then contact the requester by phone, e-mail, or similar means and direct the requester to provide additional information. Once the request form is completed, the administrator again reviews it and then examines the agreement files to determine whether a similar agreement already exists with the same company. This can be a labor-intensive process, particularly with large companies that frequently engage in the exchange of confidential information with numerous outside entities.

If a similar agreement already exists in the files, an attorney for the organization may then compare the agreement to the request form to determine if the existing agreement provides all of the coverage and required terms necessary to achieve the goals of the request form, and either authorizes a new agreement to be drafted or alerts the requester that the existing agreement will suffice. On the other hand, if no appropriate agreement exists in the files, the administrator then prepares a preliminary agreement in conformance with the terms provided on the request form. A copy of the draft is stored in the files while a draft is delivered to an attorney or other appropriate trained personnel for review. The attorney and/or administrator may need to edit the drafted agreement a number of times to ensure that proper legal provisions are included before the agreement is presented to the other party for review.

Many such agreements may be necessary in the daily course of a business' operations and must be prepared with proper legal provisions as needed, frequently with little or no advance notice. The personnel handling such requests are often not available and the tasks must be reassigned to other personnel resulting in a loss in productivity. A process is therefore required which can provide these agreements, absent human resource availability, and which meets or exceeds the expectations and business needs of the parties to the agreement.

### SUMMARY OF INVENTION

An exemplary embodiment of the invention relates to a system and method for automating administration functions in a network environment, including creating and processing non-disclosure agreements via an agreement processing and tracking application. The system includes a server, a database in communication with the server, a workstation, an input device, a computer network connecting the server to the workstation, and a network link for allowing communication with outside entities. The method includes inputting information into the workstation where it is transferred to the server and made available to the agreement processing and tracking application. An agreement processed by the application is then made available to the workstation.

### BRIEF DESCRIPTION OF DRAWINGS

Referring now to the drawings wherein like elements are numbered alike in the several FIGURES:

FIG. 1 is a block diagram of a portion of a network system that includes a plurality of workstations and servers on which the agreement processing and tracking application is implemented;

FIG. 2 is an exemplary main menu screen provided by the agreement processing and tracking application;

FIGS. 3A-3C are exemplary agreement screen windows that illustrate how a user initiates an agreement request;

FIG. 4 is a flowchart illustrating how a request for an agreement is processed by the agreement processing and tracking application;

FIG. 5 is an exemplary agreement screen window illustrating the “status” tool of the agreement processing and tracking application;

FIG. 6 is an exemplary agreement screen window illustrating the “edit” and “regeneration” tools of the agreement processing and tracking application;

FIGS. 7A and 7B represent a flowchart illustrating how the agreement processing and tracking application processes and tracks an agreement draft through the system;

FIGS. 8A-8C represents a sample non-disclosure agreement created by the agreement processing and tracking application in accordance with the present invention; and

FIG. 9 is a block diagram of a portion of a system upon which the agreement processing and tracking application is implemented in an alternative embodiment.

### DETAILED DESCRIPTION

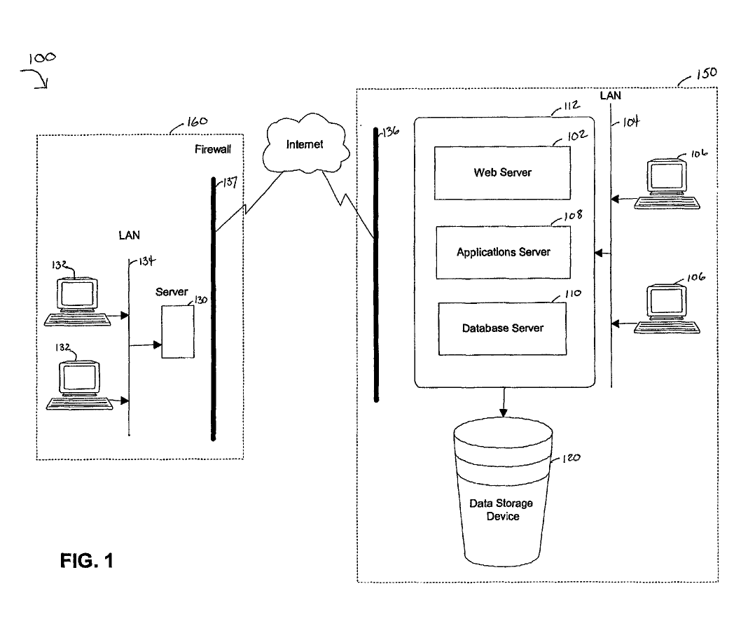

In an exemplary embodiment, the agreement processing and tracking application is implemented through a networked system such as that shown in FIG. 1. Although not necessary to realize the advantages of the present invention, system 100 may be part of a wide area network in which different geographical locations are interconnected, e.g., either by high-speed data lines or by radio links, interconnecting hundreds of workstations at widely disparate locations. In the simplified diagram of FIG. 1, system 100 includes an enterprise system 150 comprising a web server 102, an applications server 108, and a database server 110 that are located on a host system 112 and connected through a network 104 to workstations 106. Workstations 106 may comprise any suitable computer processing devices and are operated by authorized users of enterprise system 150, such as agreement requesters (herein referred to as ‘requesters’), management personnel, legal personnel, system administrators, and support staff. System administrators are tasked with updating system databases, facilitating the tracking of agreement requests and drafts, and managing access requirements for enterprise 150. The term “enterprise system” refers to an organization that is implementing the agreement processing and tracking application. Network 104 may comprise a LAN, a WAN, or other network configuration known in the art. Further, network 104 may include wireless connections, radio based communications, telephony based communications, and other network-based communications. For purposes of illustration, however, network 104 is a LAN. A firewall 136 or similar security device may be employed to limit access to enterprise system 150 to those network users possessing proper access permissions. Firewall 136 may run security software designed to provide encryption/decryption capabilities in order to ensure the security of agreement drafts being transmitted outside of enterprise system 150.

Host system 112 may be a mainframe computer or other suitable high-speed processor. Host system 112 is running suitable web server software designed to accommodate various forms of network communications, including voice, video, and text. Applications server 108 executes the agreement processing and tracking application, one of the applications utilized by enterprise system 150. Applications server 108 is also running e-mail and groupware applications through which agreement drafts and related information are delivered to targeted recipients both inside and outside of enterprise system 150. Host system 112 may also be running digital signature software for electronic signature capabilities.

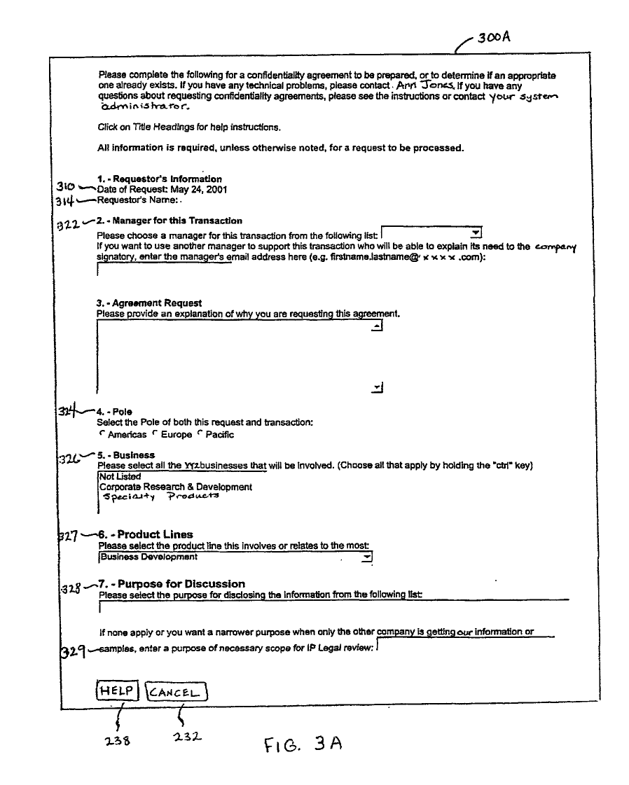

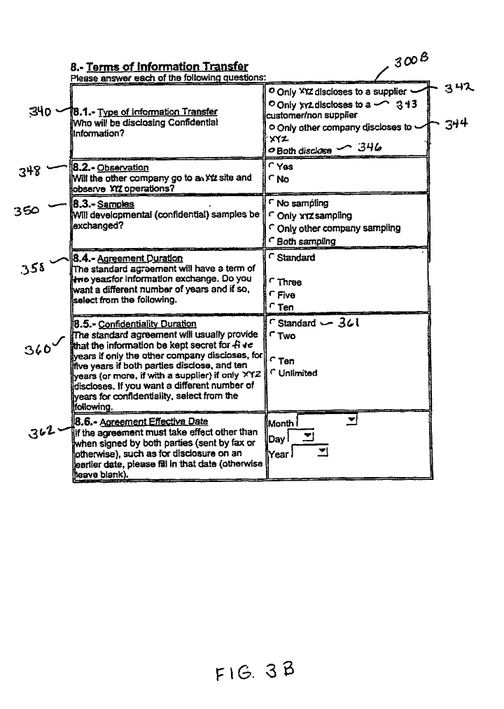

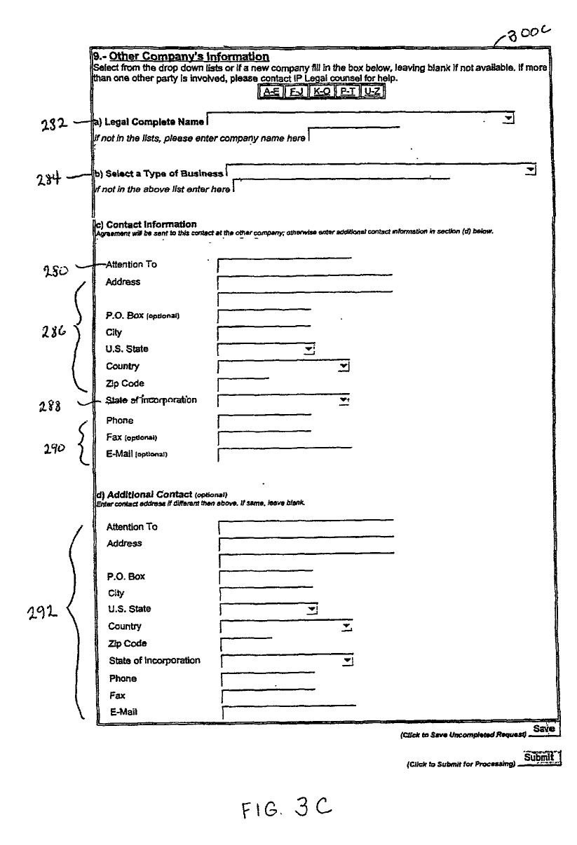

Data storage device 120 is any form of mass storage device configured to read and write database type data maintained in a file store (e.g., a magnetic disk data storage device). Of course, it will be appreciated that data storage device 120 may be one that consists of multiple disk sub-systems geographically dispersed and coupled via network architecture. There is no positive requirement that data storage device 120 be maintained in one facility; to the contrary, the volume of information stored therein may dictate geographical dispersion and the like. Data storage device 120 may be logically addressable as a consolidated data source across a distributed environment such as a network system. The implementation of local and wide-area database management systems to achieve the functionality of data storage device 120 will be readily understood by those skilled in the art. Information stored in data storage device 120 is retrieved and manipulated by database server 110 via communications with data storage device 120. Data storage device 120 provides a repository for a library of documents such as Data Information Sheets (DISs). Data Information Sheets are described in further detail in FIGS. 3A-3C. Also stored in data storage device 120 is a tracking log that records the various stages of progress involved with agreement generation. In this manner, a user at workstation 106 can access data pertaining to the status of an agreement request or agreement draft. By searching various data fields, a user can generate customizable reports used for analysis and evaluation purposes. Further, data storage device 120 houses databases used by the agreement processing and tracking application, including company address lists, agreement templates, and collections of data provided by drop down menus as described in FIGS. 3A-3C.

Third-party system 160 comprises a server 130 that connects workstations 132 to an intranet 134 and to the Internet. Firewall 137 provides security and protection against unauthorized access to internal network information from outside sources. Each of workstations 132 may access server 130 via internal web browsers (not shown) located on workstations 132. Third party system 160 may be an existing or prospective trading partner of enterprise system 150 and may be a competitor, customer, or supplier.

Requests for non-disclosure agreements, queries for updates and status information pertaining to existing agreement drafts, as well as reporting information, tracking information, and related data are inputted into enterprise system 150 via a user on a workstation running the agreement processing and tracking application. The inputted data is transferred to host system 112 and made available to the agreement processing and tracking application. The agreement processing and tracking application then formats the information into a Data Information Sheet (DIS), whereby an agreement draft is generated and processed by the application and made available to system users on workstations 106 provided by enterprise system 150. A user may also enter revisions to the draft, as well as recreate a previously-executed agreement utilizing the agreement processing and tracking application. Standardized agreement clauses and centralized rules for processing the agreements enable enterprise 150 to quickly and semi-automatically produce non-disclosure agreements while allowing users to flexibly customize the agreement terms.

Multi-tiered administrative controls maintained by system administrators and provided by the agreement processing and tracking application are defined by enterprise 150 and allow for varying levels of information access, thereby safeguarding sensitive, proprietary and confidential data. Through this tiered system, the agreement processing and tracking application also enables designated personnel to substitute and/or customize agreement clauses that are better suited to the needs of the business/department to which the personnel is assigned.

In addition, specified individuals have the ability to ‘flag’ certain types of agreement requests via the agreement processing and tracking application and its multi-tiered capabilities, enabling targeted requests and data contained therein to be distinguished from and treated separately than the others.

The agreement processing and tracking application is a semi-automated, e-business application that allows enterprise system 150 to negotiate, prepare, and track non-disclosure agreements between itself, trading partners, and other entities such as third-party system 160 and have them respond over the Internet. The application receives agreement requests, automatically transmits these requests to designated personnel or departments, generates customized agreement drafts, provides tools for editing or revising drafts throughout the drafting process, and tracks this entire process from beginning to end. The application then provides qualitative and quantitative data in report form. As discussed above, the application further allows a user to regenerate, or recreate, previously-completed agreements by providing specified data such as application version information, DIS tracking numbers and/or searching terms as described further herein. This regeneration tool alleviates the need to save and store agreements in the system, thereby freeing up valuable storage space.

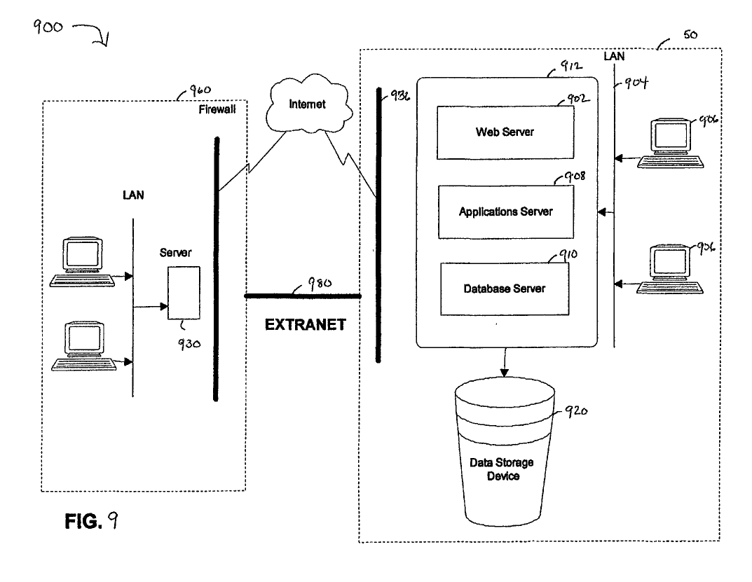

In a preferred embodiment, a requester initiates the process of generating a non-disclosure agreement by accessing the agreement processing and tracking application tool via one of workstations 106 within enterprise system 150. A requester is typically a representative of enterprise system 150 who has a need to provide, receive, or exchange confidential information for business purposes. However, as described in the alternative embodiment of FIG. 9, a requester may also be a representative of a third party enterprise such as enterprise system 160. Once the request has been received, optionally with an approval sub-process, the agreement processing and tracking application causes enterprise system 150 to draft an agreement based upon the information provided by the requester, distribute the drafted agreement to specified personnel for notification and/or further processing, and track the progress of the draft as it is processed through the system. Various entities of the system receive and provide input throughout the draft's development, and relevant tracking information is stored in the system and made available to the entities. Such entities include the requester, legal department personnel, administrators, management and support personnel, and outside third parties such as the recipient party of enterprise system 160. Because enterprise system 150 tracks and stores relevant information throughout the process via the saved DIS data and tracking log information, it allows for real-time information retrieval regarding the agreement itself or of the agreement's current status in the system, as well as a variety of reporting and analysis functions. It should be noted that enterprise system 160 may implement the agreement processing and tracking application in lieu of, or concurrently with, enterprise system 150 in order to realize the advantages of the invention. For purposes of illustration, enterprise 150 is executing the application.

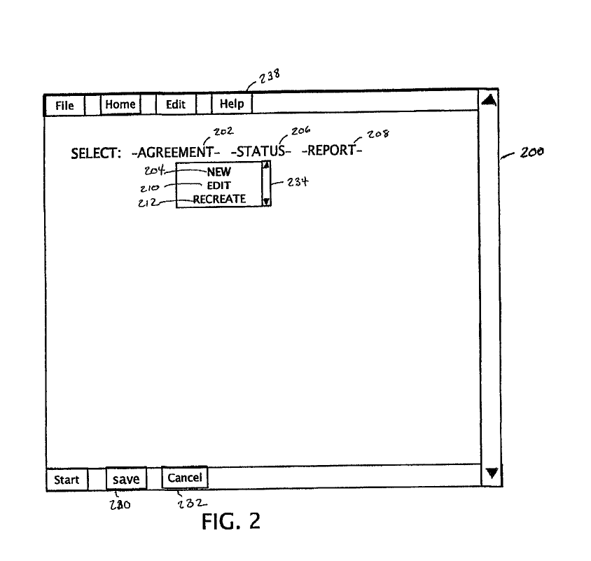

A requester initiates a request for an agreement via the main menu screen 200 of FIG. 2. A ‘requester’ may be any representative of enterprise system 150 including non-management personnel. In an alternative embodiment, a ‘requester’ may be a representative of the other party that will be receiving or providing confidential information or samples. When the requester accesses the agreement processing and tracking application via either of workstations 106, a main menu screen 200 of FIG. 2 appears on the monitor of workstation 106. The requester selects “Agreement” 202 from the list of menu items shown at the top of window 200 and “New” 204 from submenu 234. The information fields of agreement screen windows 300A-300C of FIGS. 3A-3C are then displayed. The data fields and corresponding inputs provided by a requester as illustrated in FIGS. 3A-3C are collectively referred to herein as a data information sheet (DIS). The fields displayed in windows 300A-300C may be color-coded for ease in discerning between the various parties to the agreement. For example, all information fields pertaining to the discloser may be in blue, while information fields pertaining to the recipient or third party may be in red. Third and subsequent colors may be utilized where additional parties are involved. The requester provides the data necessary for preparing the agreement as exemplified herein. The requester enters the date of the request 310, followed by the requester's name 314, division (not shown), and company identification (not shown). This information may be entered automatically based upon the requester's predetermined profile with the system or alternatively, may be selected from a drop down list provided by a company address list within the system or may be manually entered. The items provided within these drop down lists may be transported to the agreement processing and tracking application via enterprise system's 150 pre-established global address list.

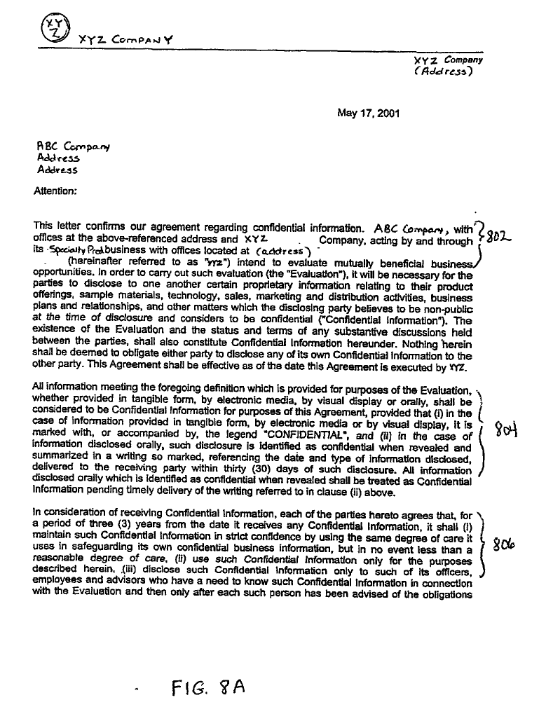

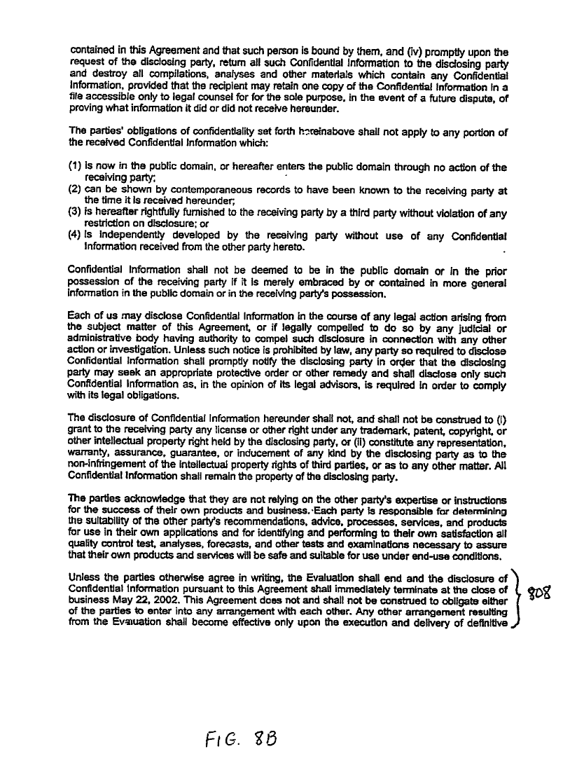

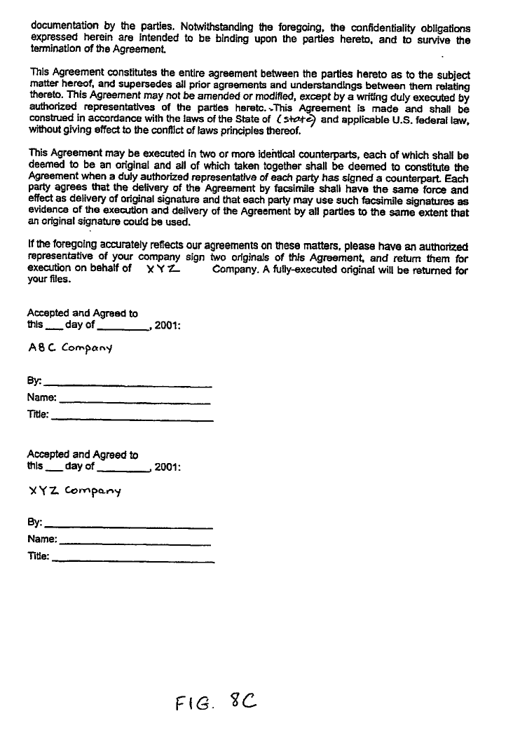

The requester may also provide the name of an appropriate individual 322 who can provide additional information, e.g., explain the need for the agreement to the company signatory of enterprise system 150, or who should be notified of the request. This name may be selected from a pre-established drop down list for convenience or the requester may manually enter a name if desired. More than one individual may be provided. In one embodiment, the system can provide an automated notification of the request to the individual, optionally with a copy of the DIS and/or the agreement draft. The agreement processing and tracking application allows a requester to select administrative assistance and/or legal support according to predetermined protocols, e.g., geographically-defined standards/locations using the “Pole” field 324. For example, a requester may select “Europe” from the drop down list of locations provided by the “Pole” field 324. The agreement processing and tracking application will search a database containing administrative and legal staff assigned to the area designated by the requester. Based upon geography, the agreement processing and tracking application determines which legal and administrative group from enterprise system 150 will be assigned to this request. This is accomplished through predefined business rules. The requester is also prompted to select a business type from a predefined list or may manually enter another business type. “Business” field 326 helps to identify and structure the agreement provisions according to predefined standards. Examples of business types might include divisions, components, or affiliates of enterprise system 150 to which the agreement will apply, such as Commercial Technology, Corporate Research and Development, Specialty Products, etc. An example may be seen in FIG. 8A, second sentence, whereby the appropriate divisions 802 of enterprise system 150 have been selected and incorporated into the agreement. If two or more business types apply to one request, the requester may select the business types desired by depressing the CTRL key on the keyboard of workstation 106 and highlighting the items desired.

The Product Line field 327 is used to identify the appropriate legal department or attorney assigned to this agreement. While pole field 324 identifies an assigned group based upon geographical location, the product line 327 further defines the appropriate legal and administrative representation based upon product line categories. For example, John Smith is the legal representative for a product line involving a new chemical being manufactured that is part of the Specialty Products division of enterprise system's 150 European pole. Additional fields may be added to further refine assignment of the agreement or provide additional input for drafting the agreement, e.g., query whether the information to be exchanged is primarily commercial in nature resulting in directing the agreement request to a commercial attorney or whether the information to be exchanged is primarily technical in nature resulting in directing the agreement request to an intellectual property attorney.

The requester is also prompted to enter the purpose for the disclosure 328 which assists the supporting legal department in evaluating the nature, scope, and propriety of the disclosure need. In some situations, a requester may plan to discuss mutually beneficial business opportunities with the recipient or to develop new products with the recipient in ajoint endeavor. Another purpose for information disclosure may include, for example, plans to discuss with the recipient possible uses of requester's product (or discuss with recipient possible uses of the recipient's product by requester's company). This information is helpful in order to understand the scope of the disclosure required so that the agreement processing and tracking application can further customize the terms of the agreement as necessary. This information may be provided by selecting from a pre-established drop down list; otherwise, the requester may enter a specific purpose for the disclosure in a separate field 329 provided by the agreement tool.

The “Help” tool 238 may be selected at any time while implementing the agreement processing and tracking application and provides explanations for the fields displayed on the agreement screen windows. Alternatively, a requester can select “Cancel” 232 at any time during this process to abandon the request if desired. Once the information is entered in the agreement screen window 300A, the requester scrolls down to the next window 300B of FIG. 3B and continues inputting requested information.

FIG. 3B illustrates by example the terms of information transfer choices available to a requester via agreement screen 300B which further defines the terms that need to be incorporated into the agreement draft. As stated above, agreements can be unilateral or bilateral. In the sample agreement screen window 300B, “XYZ Company” is the name of enterprise system 150. A requester checks the first item 342 where the requester's company or ‘discloser’ plans to give or disclose confidential information to a recipient third party who is a supplier or competitor, and seeks to bind the recipient to confidentiality. An agreement with a supplier or a competitor typically necessitates that a longer term of confidentiality be established than for an agreement with a recipient who has a limited purpose for the information. Thus, field 342 allows the requester to indicate whether the other party involved is a supplier or competitor. If the requester's company plans to disclose information to a non-supplier third party, the second item 343 is selected. A requester selects the third item 344 where the requester's company (who is, in this case, the ‘recipient’) plans to receive confidential information from a third party (in this case the ‘discloser’), which serves to bind the requester's company to confidentiality. “Both disclose”, or the fourth item 346, is chosen if both parties will be disclosing confidential information to each other and seek to bind each other to confidentiality.

The agreement processing and tracking application queries the requester to discern whether the disclosures will be oral or by visual observation 348 of a party's on-site activities (e.g., visual observation of proprietary processes). This information is useful in structuring the terms of the agreement, as illustrated generally in FIG. 8A at 804. The requester selects “Yes” of field 348 if the disclosures will be by visual observation; otherwise the “No” item is selected. The “Samples” item 350 allows the requester to designate whether one or both parties should or desire to receive sample materials of each other's products.

Other information that may be provided by the requester includes designating whether the parties to the agreement may digitally sign the agreement via the Internet or similar network, or rather if a handwritten signature on a hard copy original is preferred, (not shown), or whether disclosure of proprietary ‘tools’ such as software applications or technological devices for facilitating information transfer is desired.

The requester then indicates the time limitation for the disclosure of information via field 358. This means that all disclosures of confidential information as acknowledged in the agreement must be made within the time limitation identified by the requester via the field 358. The agreement processing and tracking application provides a default time frame of 2 years, however the requester can select a period of time up to 10 years. This is illustrated generally in FIG. 8B at 808.

In addition to the disclosure term limitation, the requester may also identify the confidentiality term appropriate for the purpose of disclosure via field 360. The confidentiality term provides that the recipient, and those employees or agents of recipient, may not reveal or disclose any confidential information received by virtue of the agreement for a period of time that is specified in the agreement. Recipients of the disclosed information must exercise due care in the handling and storage of such information for the duration of the confidentiality term. This is illustrated in the sample confidentiality agreement of FIG. 8A at 806. The system provides a default time, wherein the requester checks standard 361. However, a requester can customize the confidentiality term according to the needs of the parties involved by checking a different time frame listed.

The requester then enters the contract date 362. The contract date is the date on which the agreement is to take effect. The requester may provide the date, otherwise the agreement will take effect on the date when signed by both parties through a default mechanism set by the agreement processing and tracking application. Additionally, the contract date is stored in the tracking log in data storage device 120.

After all data has been entered in the agreement screen windows 300A and 300B of FIGS. 3A and 3B, the requester then provides information regarding the recipient party via the agreement screen window 300C of FIG. 3C. The recipient information includes the recipient's legal business name 282, followed by the type of business 284. The requester then provides contact party information, e.g., a contact party's name 280, address 286, state of incorporation 288, and telephone, facsimile, and e-mail information 290. A contact party is typically the person with whom the requester will make general communications and to whom the agreement drafts are sent. Additional contacts 292 may be listed as well. Drop down menus may be utilized for many of the above entries 280 through 292. This feature can save enterprise system 150 valuable processing time by providing instant access to stored data where multiple agreements with the same parties are entered into. If more than one recipient party is involved, the legal department is automatically notified by host system 112. As noted above, the recipient's information fields may be displayed in a different color than the discloser's information for ease in distinguishing between the two parties. Information provided in FIGS. 3A-3C is collected by the agreement processing and tracking application, formatted into a DIS sheet, automatically assigned a unique identifier, and saved in data storage device 120 for future processing. The agreement processing and tracking application may be configured by a system administrator of enterprise system 150 to allow a legal department or representative to ‘flag’ certain items or fields on agreement screen windows 300A-300C for automatic notification by e-mail. An attorney assigned to a division that handles a particular business division, agreement ‘type’, and/or product line can specify the conditions for which an automatic notification may occur. For example, an attorney may direct all agreement requests that seek to disclose a proprietary ‘tool’ or application be flagged such that the attorney will receive e-mail notification to that effect and may take pre-emptive measures to ensure absolute ‘need-to-know’ conditions are met before the agreement draft receives further processing in the system. This early notification of potential security concerns allows the attorney an opportunity to allocate more time and attention to the request/draft and to prioritize evaluations of all requests received.

The agreement processing and tracking application integrates the data in the DIS forms with predetermined agreement clauses defined by enterprise system 150 to produce comprehensive, customized documents. It should be apparent that the aforementioned queries are illustrative of the types of queries that may be made and that other queries may be used as appropriate to particular organizations or types of agreement to be generated. In addition to customizing agreement terms, the agreement processing and tracking application further allows a legal representative of organization 150 to customize the otherwise standard clauses in accordance with the particular needs of a given department. An attorney or legal representative may determine that altering an existing clause in the agreement template may provide more effective coverage in terms of the objectives of the agreement than the existing standardized clauses provide. This change may be the result of newly-adopted laws that impact this attorney's department more than others, or perhaps a change in business practices of enterprise system 150. The agreement processing and tracking application allows an attorney with proper access to customize the agreement clauses that pertain to his/her assigned areas of responsibility. The new clauses are saved in data storage device 120 and are associated with the particular version of the agreement processing and tracking application that is currently running. The reasons for this association are explained further herein.

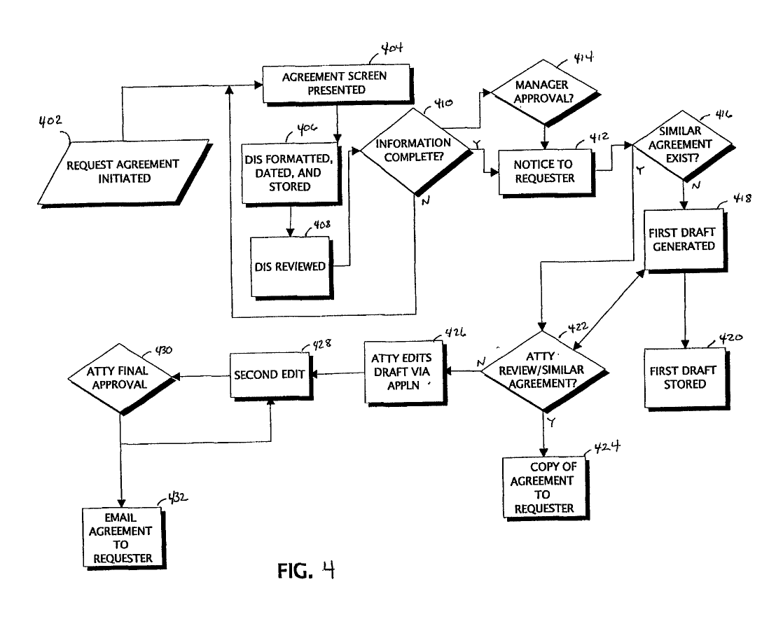

The process of generating an agreement via the agreement processing and tracking application is further described in FIG. 4 as follows. A request for a new agreement is entered at step 402. At step 404, the agreement processing and tracking application queries the requester to enter general information regarding the nature and purpose of the request, as well as identification information regarding the other party (‘recipient’) for which the request is needed. The information is provided by the requester via the agreement screen windows of FIGS. 3A-3C. This information is formatted into a Data Information Sheet (DIS) document, dated, and stored in the system at step 406. The agreement processing and tracking application generates a ‘start date’, typically the current date of the request, and stores the date for reasons that will be further explained herein. Once this information has been provided by the requester, the agreement processing and tracking application reviews the DIS at step 408 and checks to see if all necessary data has been provided by the requester at step 410. If the DIS is incomplete, host system 112 notifies the requester that information is missing and the process returns to step 404 where steps 404 through 410 are repeated. When the information provided by the requester is complete, flow proceeds to step 412 where host system 112 notifies the requester that the request is pending and that the requester will be informed of activities occurring throughout the drafting process where appropriate. The agreement processing and tracking application can be optionally configured so that the system checks for manager approval at step 414 before continuing the processing of the request. The agreement processing and tracking application may be programmed to compare the information on the DIS to the DIS files stored in data storage device 120 for similarities at step 416 in order to determine if a current agreement already exists. This process includes checking enterprise system's 150 company address list and determining whether the recipient's name currently exists in the system. The information may exist in the system because the requester's company has done business with the recipient in the past and may even be subject to an existing non-disclosure agreement. If no similar DIS exists in the system, the agreement processing and tracking application generates a first draft of the agreement from the DIS information at step 418, and saves the draft in data storage device 120 at step 420. If, however, a similar DIS already exists in the system, the system may be programmed to automatically deliver the DIS to an assigned attorney for a closer review at step 422. The attorney is assigned via the “Pole” 324 input, “Business” type 326 input, and Product Line 327 input as described in above in FIG. 3. The attorney examines the terms of the similar DIS documents and determines whether the existing DIS(s) incorporate(s) all of the necessary terms provided in the current DIS, thereby eliminating the need to generate a new agreement. If an existing DIS incorporates the terms of the current DIS, the attorney sends a copy of the existing agreement to the requester for notification at step 424 and disapproves the request. The attorney may also disapprove the request for other reasons. For example, the attorney may determine based upon the information given by the requester that an agreement is not necessary. In this case, host system 112 would send a disapproval notice to the requester's workstation along with an explanation from the assigned attorney. In either case, host system 112 marks the request “complete” and deletes it from the system (not shown).

If the existing DIS does not overlap with the current DIS, the attorney then authorizes a first draft to be created in the system at step 418. The host system 112 may also mark the date of the authorization as the same date as the “start date” of the requester's original request. The start date is used for tracking purposes. It allows the system to track the amount of time the draft remains in the system before being finalized or abandoned and may optionally send periodic reminders to appropriate personnel during periods of inactivity. Host system 112 sends a notice to the requester that the request has been approved and permits the requester to move forth with the process. In an alternative embodiment, a draft is automatically generated based upon the DIS without a comparison for similar DIS in the system. The requester is optionally sent an acknowledgement that the DIS has been received and has been submitted to the appropriate individuals for review and drafting. This acknowledgment may be sent via e-mail and may optionally contain the names of the individuals that will review the draft. Once created, the draft is automatically available or transmitted to the attorney for review at step 422 and stored in data storage device 120 at step 420. The attorney edits the draft as necessary via the agreement processing and tracking application at step 426. Subsequent revisions may be required as the draft is transmitted to designated persons or departments at step 428. Once all revisions are complete, flow proceeds to step 430 where the attorney gives final approval of the draft. The draft is then e-mailed to the requester at step 432 indicating that it is ready to be delivered to the recipient at third party system 160 for review and further action.

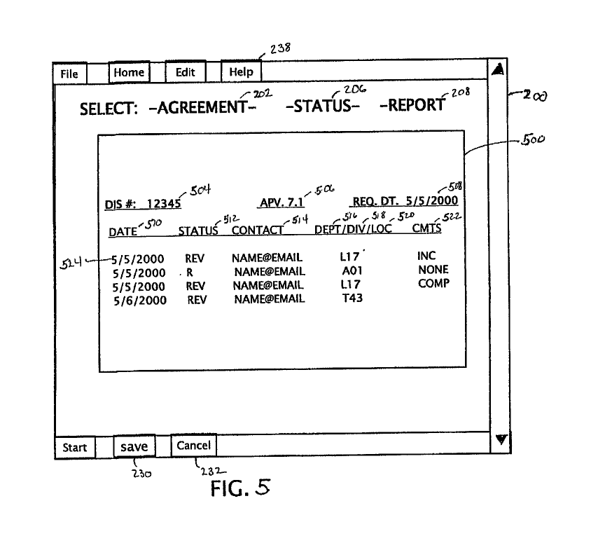

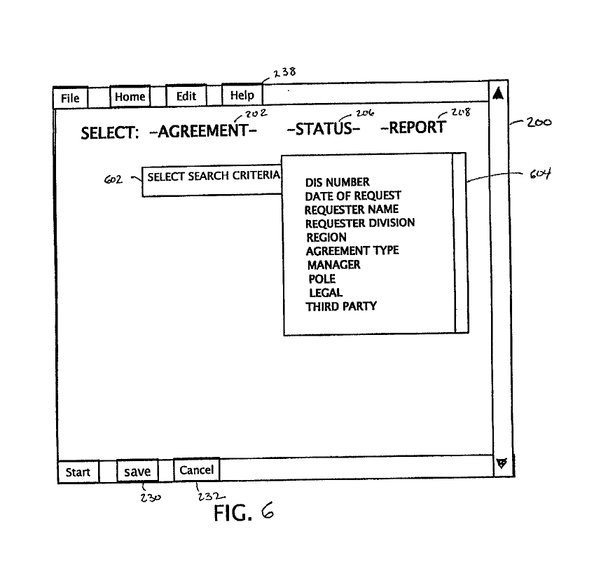

As described earlier, an authorized party of enterprise system 150 may track the progress of a request or draft as it is processed through the system. FIG. 5 illustrates this process. A requester accesses the agreement processing and tracking application using an assigned password and ID and selects “Status” 206 from the menu items displayed on agreement screen window 200. The agreement processing and tracking application queries the requester to select from a list of search criteria shown in FIG. 6. A requester can search for a pending request using one or more of the listed search fields provided in window 604 of FIG. 6. Allowing search criteria to be defined by a user facilitates the searching process, providing quick and easy access to this status information. It is important to note that any information obtained via the status tool provides read-only data for the general user population in order to protect the information from accidental loss or destruction.

The user selects one or more items from the search criteria of window 604, and the agreement processing and tracking application searches data storage device 120, retrieving the appropriate DIS information from the tracking log. The status information is displayed as shown in window 500 of FIG. 5 and includes DIS identifier 504, the applicable version of the agreement processing and tracking application 506, and the request date 508. The remaining information provides an historical representation of the transactions that occurred for the DIS. The “Date” column 510 indicates the date on which the transaction occurred. The “Status” column 512 indicates what action was taken on that date. The “Contact” column 514 provides the name and e-mail address of the person who took the indicated action shown. The “Dept/Div/Loc” column 516, 518, and 520 respectively, identifies the location of the person who took the action. The “Cmts” column 522 enables the person taking action to provide additional comments pertaining to the DIS via the “Edit” tool. For example, line 524 shows a single transaction occurring for DIS 504. On May 5, 2000, DIS 504 was being reviewed by a contact person whose name and email are listed. This contact person is assigned to Department “L”, Division “1”, and Location “7”.

FIG. 6 illustrates how an authorized user edits agreement drafts via the “Edit” tool and recreates finalized agreements via the “Regeneration” tool. The “Edit” tool enables a user to edit information previously entered on DIS or modify existing agreement clauses and may be initiated in situations where an administrator, attorney, and/or third party renegotiate agreement terms or where a manager or high level administrator do not approve of the terms as originally entered by a requester. As an agreement draft travels through the drafting process, it is likely that changes will need to be made. The agreement processing and tracking application provides the means by which editing functions can be performed by various individuals at enterprise system 150 according to their assigned access levels.

The “Regeneration” tool is another feature of the agreement processing and tracking application. As explained above, although drafts are temporarily stored in the system during the processing phase, the final agreements need not be saved in the system. Knowing an associated DIS identifier along with the particular version (e.g., APV.7.1 506 of FIG. 5) of the agreement processing and tracking application in effect at the time the agreement was processed allows a user to recreate the original agreement when desired. DIS sheets are stored in the system, and the agreement processing and tracking application can integrate the data on the DIS using the version of the application that was in effect at the time of the request, and recreate an original document complete with the parties' signatures. Digital signatures software running on enterprise system 150 allows secure and authenticated personal signatures to be reproduced via the agreement processing and tracking application. The “Regeneration” tool is accessed by selecting the “Agreement” item 202, followed by “Recreate” 212 from submenu 234 of FIG. 2. The “Select Search Criteria” 602 window of FIG. 6 appears. The user selects “OK” (not shown) from window 602, and the criteria list window 604 is displayed. The user may search for an agreement by one or more of the criteria listed in window 604. The agreement processing and tracking application causes database server 110 to search data storage device 120 for the criteria entered by the user. The corresponding DIS is displayed which identifies the particular application version of the agreement processing and tracking application. The user selects “Go” (not shown) from the menu provided and the agreement processing and tracking application integrates the template information and agreement clauses from the appropriate application version with the data stored on the respective DIS. It also provides the digital signatures of the parties who signed the agreement, resulting in a recreation of a complete and original agreement. Digital signatures are associated with the recreated agreement utilizing the version number and corresponding DIS number. The “Regeneration” tool alleviates the need to store agreements, saving valuable storage space.

The “Edit” tool allows an authorized user to revise an agreement draft as necessary. The user edits an agreement draft by selecting “Agreement” 202 from the agreement screen window 200, followed by “Edit” 210 from submenu 234. The “Select Search Criteria” window 602 appears. The user selects “OK” (not shown) from window 602, and the criteria list window 604 is displayed. The user may search for an agreement by one or more of the criteria listed in window 604. The agreement processing and tracking application causes database server 110 to retrieve the associated DIS stored in data storage device 120 and presents it to the user for editing. A user may only edit fields in accordance with the tiered access levels granted via the agreement processing and tracking application as described above. Once the revisions are made, the user selects “Save” 230 and the revised DIS is stored in data storage device 120. Notices are generated by the agreement alerting the designated personnel that revisions have been made (not shown). In one embodiment, after both parties to the agreement have provided signatures, the “Edit” tool can no longer be accessed for that particular DIS, preventing any subsequent modifications to be made, thus, preserving the integrity of the final agreement.

Once the draft has been approved by all appropriate departments of enterprise system 150, it is ready to be transmitted to the requester and/or the third party at enterprise system 160 for review. The agreement processing and tracking application allows enterprise system 150 to e-mail agreement drafts to entities outside of enterprise system 150 which can significantly reduce the overall processing time attributable to old methods involving commercial mail and physical delivery. The agreement may be converted to a common data format such as a PDF or common text file and attached to an e-mail message. Enterprise system 150 is running security software such as encryption/decryption in order to maintain the confidentiality of the communications.

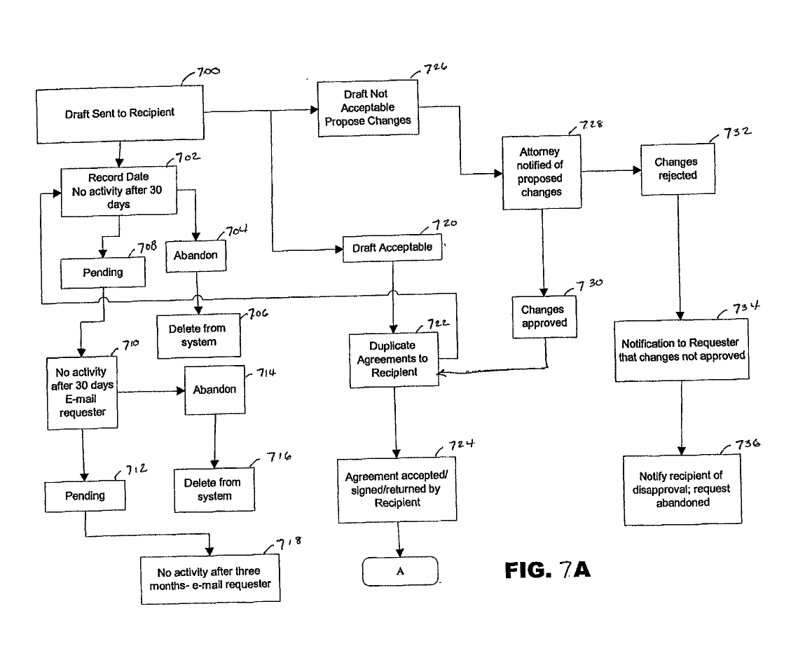

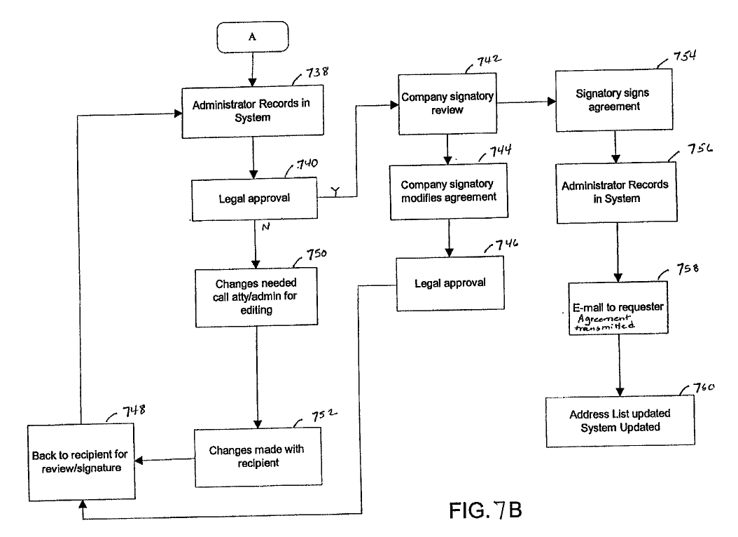

FIGS. 7A and 7B further illustrate the processing of the agreement draft as it proceeds between enterprise system 150 and third party system 160. At step 700, the requester e-mails the agreement draft to the recipient for review along with instructions regarding its handling and signature requirements.

Host system 112 notes the date and tracks the amount of time that has elapsed while the recipient is in custody of the draft. If no activity occurs within a predetermined period, e.g., 30 days, after the recorded “start date”, host system 112 sends an e-mail to the requester (with a copy to the assigned attorney) requesting a status update at 702. The requester or attorney may then enter the current status of the draft into the system, where it is recorded. If the requester decides to abandon the draft, host system 112 marks the status as “abandoned” at step 704, and the agreement is then deleted by host system 112 from the system at 706. If the draft is still pending, the requester identifies it as such at step 708, and the process continues to step 710. At 710, the system once again measures the amount of time elapsed from the date in which the requester marked the status as pending. As before, if no activity occurs within the predefined period, the attorney or requester either marks the status as pending at 712, or abandons and deletes the request at 714 and 716 respectively. If, after, e.g., three months from the start date no activity has occurred, host system 112 notifies the requester that the request will be deleted from the system within seven days if the agreement has not been signed (step 718).

Alternatively, the recipient 160 may review the agreement and respond within 30 days, whereby one of two scenarios is possible. At step 720, the recipient responds affirmatively that the agreement as sent by requester is accepted. The requester then prepares duplicate agreements and forwards to the recipient at step 722 and again, the system tracks the time as described in steps 702-718. Signatures can be performed manually or digitally whereby the signatory executes the agreement utilizing a smart card, handprint, or other acceptable device as is known in the art. Once the agreement is signed by the recipient at 724, flow then proceeds to FIG. 7B.

In a second scenario at step 726, the recipient notifies the requester or administrator that it does not accept the agreement as originally drafted and proposes changes or modifications. An e-mail notification detailing the proposed changes is sent to the attorney at 728 via host system 112. The attorney reviews the proposed changes, and makes a determination whether they should be incorporated (or approved) at step 730, or disapproved at step 732. If disapproved, flow proceeds to step 734 where the requester is informed that the proposed changes have been disapproved. The requester notifies the recipient and the request is abandoned at step 736. In this instance, the requester may re-institute the request process as shown in FIG. 4. If the changes are approved, the requester incorporates the changes utilizing the “Edit” tool (described in FIG. 6) and flow returns to step 722.

Once the agreement is accepted, signed, and returned by the recipient, it is forwarded to an administrator at step 738 who updates the system accordingly. Flow then proceeds to step 740 where the legal department reviews it. If the agreement is acceptable, it is presented to the company signatory for review at 742. Should the signatory decide to modify the agreement before signing at step 744, the host system 112 notifies the legal department. The legal department reviews the modifications as suggested by signatory at step 746. This may occur where the modifications are substantive in nature, affecting the party's rights, as opposed to mere technical or grammatical changes. Flow then proceeds to step 748, where the agreement is sent to the recipient for review and signature. Once signed, the agreement is sent to the administrator who updates the system at 738. At step 740, the legal department must again sign off on the revised agreement before it is presented to the signatory as illustrated above at step 742.

Alternatively, at step 728, if before being presented to the signatory, the legal department discovers an error in the agreement or otherwise determines a problem exists, it may choose not to approve the agreement, but instead make revisions at step 750. Once revised, the agreement is returned to the recipient at 752 for review and signature.

If, on the other hand, both the legal department as well as the signatory determine that the agreement is acceptable, the agreement is executed at step 754 and returned to the administrator at 756 who updates the system. Host system 112 generates forwarding letters or e-mails to accompany the agreement during transmittal to both the recipient and the requester at step 758. Additionally in one embodiment, the system is updated at 760 to identify that the transaction has been completed and the system is updated with information relating the agreement, e.g., the effective date of the agreement, the duration of the agreement or confidentiality period, its expiration date, and the date the agreement was signed by the requester's company (“discloser”). Host system 112 also updates the company address list to include the new agreement, and prints a data sheet for placement in the agreement files.

FIG. 8 illustrates a non-disclosure agreement template in a preferred embodiment of the present invention. As shown in FIG. 8, the agreement comprises information regarding the discloser's business as well as legal text commonly found in non-disclosure agreements and which are known to those skilled in the art. The agreement text indicates the particularized agreement terms as provided by the requester via the agreement screen windows 300A-300C of FIGS. 3A-3C. As described above in FIG. 7, the system then processes the drafted agreement, tracking its status until it is finalized by the parties and recorded in the system.

FIG. 9 illustrates a network system 900 through which the agreement processing and tracking application may be implemented in an alternative embodiment. Network system 900 is configured in a manner similar to that of system 100 of FIG. 1, except unlike enterprise system 150, enterprise system 950 shares a private, extended intranet connection, or extranet 980, with enterprise system 960. An extranet can be compared to an intranet system that is partially accessible to authorized third parties outside of the intranet system. Extranets are popular network configurations primarily used in business-to-business interactions and are generally known in the art. Because outside entities are given partial access to internal applications, security precautions are essential. Accordingly, system 900 includes firewall 936 that operates one or more security devices to protect system 950 from unauthorized access to its proprietary information. Examples of such security devices include a packet-filtering router, an application-level gateway (or proxy server), a circuit-level gateway and/or other security devices known in the art.

For purposes of illustration, firewall 936 is operating a public key infrastructure (PKI) for the encryption/decryption of non-disclosure materials transmitted between system 950 and system 960. Access to internal data and applications may be restricted by implementing a name/password-type system, digital certificates, tokens, smart cards, or other security measures known in the art. With extranet 980 in place, a requester from enterprise system 960 may initiate a request for a non-disclosure agreement with enterprise system 950 by utilizing the security devices described above. Extranet 980 provides both enterprise systems 950 and 960 a secure connection through which each can receive and disseminate confidential information including agreement requests, drafts and tracking data. Because a requester from enterprise system 960 does not possess complete access to enterprise system 950, important proprietary applications and data are safeguarded. Authorized users of extranet 980 are listed in a directory stored in data storage device 920. This information is alterable only via high-level administrative personnel of enterprise system 950 for security purposes. The process of initiating a request for a non-disclosure agreement is similar to that described in FIGS. 3-7, and therefore will not be discussed in detail. An authorized requester from enterprise system 960 can access many of the tools provided by the agreement processing and tracking application, such as checking the status of a request (FIG. 5), editing pending agreement drafts (FIG. 6), and other tools as desired by enterprise system 950. This ability to obtain self-service information reduces the amount of time enterprise system 950 personnel must spend communicating with its extranet partners via other communications channels and shortens the time traditionally spent in the agreement drafting process.

As indicated above, the system is not limited to processing agreement drafts and tracking their progress, but is also capable of performing various administrative tasks such as providing searching and reporting functions. This information is useful to the discloser in order to evaluate and develop its business plans and practices.

The present invention streamlines the process of preparing standard agreements, e.g. confidentiality or non-disclosure agreements, by reducing the amount of human intervention that is typically required utilizing traditional methods. Also, the system itself ‘drafts’ the agreement upon receiving specific information from a requester thereby reducing the time expended in manually drafting an agreement. Because the system automatically transmits the agreement and related information to relevant personnel throughout the system, an accurate and effective tracking process is provided. The system allows for any number of agreements to be drafted as necessary as there are no time constraints due to personnel limitations. Additionally, various legal issues may be handled more expeditiously by keeping the legal department in the loop throughout the drafting process.

As described above, the present invention can be embodied in the form of computer-implemented processes and apparatuses for practicing those processes. The present invention can also be embodied in the form of computer program code containing instructions embodied in tangible media, such as floppy diskettes, CD-ROMS, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A system for automating administration functions in a network environment, the system usable in creating and processing non-disclosure agreements, the system comprising:
a server;
a database in communication with said server, said database including a company address list;
an agreement processing and tracking application in communication with said server;
a workstation;
an agreement screen window on the workstation;
an input device for inputting information by a requester, said information prompted by the agreement screen window;
a computer network for allowing the server, the database, and the workstation to communicate with each other; and
a network link for allowing said system to communicate with outside entities; wherein said information inputted into the workstation is transferred to the server and made available to the agreement processing and tracking application and an agreement processed by the application is made available to the workstation.

2. The system of claim 1 further comprising a plurality of workstations and a plurality of servers connected to one another via the network.

3. The system of claim 1, further comprising digital signature software.

4. The system of claim 1 wherein the agreement screen window includes a first color designating a first party in the agreement and a second color, different than the first color, designating a second party in the agreement.

5. The system of claim 1 wherein the agreement screen window includes screen-activatable buttons for selecting an agreement type from a set including one way give, one way receive, sampling, visual observation of proprietary processes, and two-way give and receive.

6. The system of claim 1 wherein the agreement screen window includes spaces for receiving manually entered information regarding company information, and wherein the server compares the company information to the company address list in the database.

7. The system of claim 1 wherein said information prompted by said agreement screen window includes data identifying:
a business type;
a product line;
an agreement type; and
an agreement purpose.

8. The system of claim 1, wherein said information is transferred to a data information sheet.

9. The system of claim 8, wherein said data information sheet is associated with a unique identifier.

10. The system of claim 1, wherein said agreement processing and tracking application is assigned a version identification.

11. The system of claim 1, wherein said agreement processing and tracking application automatically generates and transmits a notification to a legal representative based upon said information provided by said requester.

12. The system of claim 1 wherein said network link is an extranet.

13. A method of semi-automatically creating and processing a non-disclosure agreement, the method including:
providing a workstation;
initiating an agreement processing and tracking application on the workstation to request a non-disclosure agreement;
completing an agreement screen window on the workstation by inputting requested data relating to agreement requirements and company information;
sending data entered in the agreement screen window over a network to an attached server;
comparing company information entered on the workstation to a company address list located in a database on the server;
processing said data; and
generating an agreement based on data entered in the agreement screen window.

14. The method of claim 13 wherein the completing an agreement screen window includes selecting desired agreement requirements from pull-down menus, selecting agreement type, and manually entering company information relating to parties of the agreement.

15. The method of claim 13 wherein comparing company information entered on the workstation to a company address list located in a database on the server includes sending a notice to a legal representative if the company information matches information in the database.

16. The method of claim 15 further comprising reviewing any previous files relating to the company information and determining whether an agreement should still be made.

17. The method of claim 13 wherein generating an agreement includes printing a copy of the agreement.

18. The method of claim 13, further comprising sending a message over the network relaying whether the agreement is approved or disapproved by a legal representative.

19. The method of claim 13 wherein initiating a non-disclosure agreement includes noting a start date for tracking purposes.

20. The method of claim 19 further comprising tracking how long the agreement takes to be finalized or abandoned.

21. The method of claim 20 further comprising sending periodic reminders to appropriate personnel during periods of inactivity.

22. The method of claim 21 further comprising deleting the request for a confidentiality agreement after a predetermined time period of inactivity.

23. The method of claim 20 further comprising updating the system on the workstation with information relating to status of the agreement.

24. The method of claim 23 wherein updating the system on the workstation includes entering signature date and termination date.

25. The method of claim 13 wherein generating an agreement includes integrating said data entered in said agreement screen window with templated legal clauses.

26. The method of claim 25 wherein said templated legal clauses are customized.

27. The method of claim 13, wherein said processing said requested data includes:
formatting said data into a data information sheet;
automatically assigning a unique identifier to said data information sheet; and
storing said data information sheet in said database.

28. The method of claim 13, further comprising:
configuring said agreement processing and tracking application to allow an authorized user to set a flag at a data field in said agreement screen window, wherein when activated, said flag causes the agreement processing and tracking application to automatically transmit a notice to a legal representative.

29. The method of claim 13, further comprising:
configuring said agreement processing and tracking application to allow an authorized user to customize standard agreement clauses in a non-disclosure agreement template.

30. The method of claim 29, wherein said agreement clauses are stored in a database and associated with a version number of said agreement processing and tracking application.

31. The method of claim 13, further comprising configuring said agreement processing and tracking application to require manager approval of said request for said non-disclosure agreement before said request is processed.

32. The method of claim 27, wherein said agreement processing and tracking application compares information in said data information sheet with data information sheet files stored in said database in order to determine if a current agreement exists.

33. The method of claim 13, further comprising regenerating a previously created agreement, including:
providing a version identification of said agreement processing and tracking application for which said previously created agreement was drafted;
providing a data information sheet number corresponding to said previously created agreement, wherein said agreement processing and tracking application searches said database, retrieves said data information sheet and recreates said agreement using said version identification.

34. The method of claim 13, wherein said agreement processing and tracking application restricts access to editing functions related to said agreement upon legal execution of said agreement.

35. A computer workstation comprising:
an input device;
a mouse;
a monitor;
a user-interactive window displayable on the monitor for initiating a non-disclosure agreement request, the window comprising a plurality of information fields for entering agreement requirements, wherein the fields include blank spaces, pull-down menus, and checkboxes, completable by manually entering data from the keyboard or by selecting items with the mouse; and,
a network connection for connecting the workstation to a server for generating an agreement based on agreement requirements entered in the information fields.

36. The workstation of claim 35 wherein information fields relating to a first party are in a first color and information fields relating to a second party are in a second color, different than the first color.

37. The workstation of claim 35 wherein a computer generated start date is added to the non-disclosure agreement request.

38. The workstation of claim 35 wherein the information fields include checkboxes listing types of agreements, a pull-down menu itemizing purposes for an agreement, and blank spaces adjacent read-only indicia relating to the blank spaces.

39. The workstation of claim 38 wherein the read-only indicia includes indicia requesting company information.

40. The workstation of claim 38 wherein the information fields further include a pull-down menu itemizing managers responsible for different projects.

41. A storage medium encoded with machine-readable computer program code for semi-automatically creating and processing a non-disclosure agreement, the storage medium including instructions for causing a computer to implement a method comprising:
providing a workstation;
initiating an agreement processing and tracking application on the workstation to request a non-disclosure agreement;
completing an agreement screen window on the workstation by inputting requested data relating to agreement requirements and company information;
sending data entered in the agreement screen window over a network to an attached server;
comparing company information entered on the workstation to a company address list located in a database on the server;
processing said data; and
generating an agreement based on data entered in the agreement screen window.

42. The storage medium of claim 41 wherein the completing an agreement screen window includes selecting desired agreement requirements from pull-down menus, selecting agreement type, and manually entering company information relating to parties of the agreement.

43. The storage medium of claim 41 wherein comparing company information entered on the workstation to a company address list located in a database on the server includes sending a notice to a legal representative if the company information matches information in the database.

44. The storage medium of claim 43 further comprising instructions for causing a computer to implement:
reviewing any previous files relating to the company information and determining whether an agreement should still be made.

45. The storage medium of claim 41 wherein generating an agreement includes printing a copy of the agreement.

46. The storage medium of claim 41, further comprising instructions for causing a computer to implement:
sending a message over the network relaying whether the agreement is approved or disapproved by a legal representative.

47. The storage medium of claim 41 wherein initiating a non-disclosure agreement includes noting a start date for tracking purposes.

48. The storage medium of claim 47 further comprising instructions for causing a computer to implement:
tracking how long the agreement takes to be finalized or abandoned.

49. The storage medium of claim 48 further comprising instructions for causing a computer to implement:
sending periodic reminders to appropriate personnel during periods of inactivity.

50. The storage medium of claim 49 further comprising instructions for causing a computer to implement:
deleting the request for a confidentiality agreement after a predetermined time period of inactivity.

51. The storage medium of claim 48 further comprising instructions for causing a computer to implement:
updating the system on the workstation with information relating to status of the agreement.

52. The storage medium of claim 51 wherein updating the system on the workstation includes entering signature date and termination date.

53. The storage medium of claim 41 wherein generating an agreement includes integrating said data entered in said agreement screen window with templated legal clauses.

54. The storage medium of claim 53 wherein said templated legal clauses are customized.

55. The storage medium of claim 41, wherein said processing said requested data includes:
formatting said data into a data information sheet;
automatically assigning a unique identifier to said data information sheet; and
storing said data information sheet in said database.

56. The storage medium of claim 41, further comprising instructions for causing a computer to implement:
configuring said agreement processing and tracking application to allow an authorized user to flag said data fields, wherein when activated, said flag causes the agreement processing and tracking application to automatically transmit a notice to a legal representative.

57. The storage medium of claim 41, further comprising instructions for causing a computer to implement:
configuring said agreement processing and tracking application to allow an authorized user to customize standard agreement clauses in a non-disclosure agreement template.

58. The storage medium of claim 53, wherein said agreement clauses are stored in a database and associated with a version number of said agreement processing and tracking application.

59. The storage medium of claim 41, further comprising instructions for causing a computer to implement:
configuring said agreement processing and tracking application to require manager approval of said request for said non-disclosure agreement before said request is processed.

60. The storage medium of claim 55, wherein said agreement processing and tracking application compares information in said data information sheet with data information sheet files stored in said database in order to determine if a current agreement exists.

61. The storage medium of claim 41, further comprising instructions for causing a computer to implement:
regenerating a previously created agreement, including:
providing a version identification of said agreement processing and tracking application for which said previously created agreement was drafted;
providing a data information sheet number corresponding to said previously created agreement, wherein said agreement processing and tracking application searches said database, retrieves said data information sheet and recreates said agreement using said version identification.

62. The storage medium of claim 41, wherein said agreement processing and tracking application restricts access to editing functions related to said agreement upon legal execution of said agreement.
